(19) United States
(12) Patent Application Publication
(10) Pub. No.: US 2013/0221595 A1
(43) Pub. Date: Aug. 29, 2013

(54) SUBSTRATE CARRIER PLATE

(71) Applicants: Steven VERHAVERBEKE, San Francisco, CA (US); Roman GOUK, San Jose, CA (US)

(72) Inventors: Steven VERHAVERBEKE, San Francisco, CA (US); Roman GOUK, San Jose, CA (US)

(73) Assignee: Applied Materials, Inc.

(21) Appl. No.: 13/764,132

(22) Filed: Feb. 11, 2013

Related U.S. Application Data
(60) Provisional application No. 61/604,419, filed on Feb. 28, 2012.

(51) Int. Cl. B05C 13/02

(52) U.S. Cl. CPC B05C 13/02
USPC 269/287

(57) ABSTRACT

A method and apparatus for processing multiple substrates simultaneously is provided. In one embodiment, a carrier plate for supporting a plurality of substrates is provided. The carrier plate comprises a disk-shaped body having a first side and a substantially planar second side opposite the first side, and a plurality of depressions formed in the first side of the disk-shaped body. Each of the plurality of depressions comprise a sidewall tapering from a surface of the first side and a bottom surface of the depression, and a support structure disposed above the bottom surface of, and geometrically centered in, the depression.

### CROSS-REFERENCE TO RELATED APPLICATIONS

This application claims benefit of U.S. Provisional Patent Application Ser. No. 61/604,419 (Attorney Docket No. 016835USL) filed on Feb. 28, 2012, which is hereby incorporated by reference herein.

### FIELD

1. Field of the Invention

Embodiments described herein relate to a substrate carrier plate for supporting a plurality of substrates during transfer and/or processing in an automated system. More specifically, embodiments described herein relate to a substrate carrier plate utilized in batch processing of substrates, such as substrates utilized in the production of magnetic media devices.

2. Background

Magnetic media devices are used in various electronic products such as hard disk drives and magnetoresistive random access memory (MRAM) devices. Hard-disk drives are the storage medium of choice for computers and related devices. Hard-disk drives are found in most desktop and laptop computers, and may also be found in a number of consumer electronic devices, such as media recorders and players, and instruments for collecting and recording data. Hard-disk drives are also utilized in arrays for network storage. MRAM devices are used in various non-volatile memory devices, such as flash drives and dynamic random access memory (DRAM) devices.

Magnetic media devices store and retrieve information using magnetic fields disposed on a disk. The disk in a hard-disk drive is configured with magnetic domains that are separately addressable by a magnetic head. The magnetic head moves into proximity with a magnetic domain formed on the disk and alters the magnetic properties of the domain to record (i.e., “write”) information. To recover the recorded information, the magnetic head moves into proximity with the domain to detect (i.e., “read”) the magnetic properties of the domain. The magnetic properties of the domain are generally interpreted as corresponding to one of two possible states, the “0” state and the “1” state. In this way, digital information may be recorded on the magnetic medium and recovered thereafter.

Disks utilized for magnetic storage media generally comprise a disk-shaped, annular substrate having a central aperture formed therethrough. The substrate may be made of a glass, a composite glass/ceramic, or a metal, which is generally non-magnetic, with a magnetically susceptible material disposed thereon. To increase storage capacity of the disk, the magnetically susceptible material may be deposited on both sides of the substrate. The magnetically susceptible material may be further processed to form patterns on the magnetically susceptible material. Protective coatings may also be deposited on the magnetically susceptible material.

Conventional processing systems typically perform these deposition processes one substrate at a time In one conventional process, a single substrate is disposed in a chamber between deposition devices that face opposing sides of the substrate, which enables deposition on both sides of the substrate. However, the single substrate process is time consuming, and the one substrate per chamber system requires a large footprint to achieve high throughput. These factors make batch processing more desirable. Further, some conventional systems support the substrate by an outer edge during deposition, which decreases the surface area available for deposition. This creates an edge exclusion zone on the periphery of the substrate, which may decrease the area available for deposition and thus, the memory capacity of the disk.

While batch processing systems increase production, challenges persist in handling of the substrates, and particularly, prevention of damage to sides of the substrate that have been previously processed. Such damage may adversely affect storage capacity or the ability of the magnetically susceptible material to be read or written. The damage may result in an unusable or severely impaired storage device. Additionally, challenges arise in the support of the substrate during deposition, making it difficult to perform deposition without any edge exclusion on the periphery of the substrate.

Therefore, what is needed is a substrate support plate that may be utilized in a batch system that prevents or minimizes damage to sides of the substrate that has been previously processed, and increases available surface area for deposition.

### SUMMARY

A method and apparatus for simultaneously processing multiple substrates is provided. In one embodiment, a carrier plate for supporting a plurality of substrates is provided. The carrier plate comprises a disk-shaped body having a first side and a substantially planar second side opposite the first side, and a plurality of depressions formed in the first side of the disk-shaped body. Each of the plurality of depressions comprise a sidewall tapering from a surface of the first side and a bottom surface of the depression, and a support structure disposed above the bottom surface of, and geometrically centered in, the depression. The profile of the depression may be configured to match the profile of the substrate, such as the circular profile of a storage disk substrate.

In another embodiment, a carrier plate for supporting a plurality of substrates is provided. The carrier plate comprises a disk-shaped body having a first side and a substantially planar second side opposite the first side, and a plurality of pockets formed in the first side of the disk-shaped body. Each of the pockets comprise a sidewall disposed between a surface of the first side and a bottom surface of the pocket, and a support structure disposed above the bottom surface, the support structure comprising one or more substantially semicircular support surfaces.

In another embodiment, a carrier plate for supporting a plurality of substrates is provided. The carrier plate comprises a disk-shaped body having a first side and a substantially planar second side opposite the first side, and a plurality of pockets formed in the first side of the disk-shaped body. Each of the pockets comprise a sidewall tapering from a surface of the first side and a bottom surface of the pocket, and a support structure comprising one or more substantially semicircular support surfaces disposed above the bottom surface of, and geometrically centered in, the pocket.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a top plan view of a substrate carrier plate according to one embodiment of the invention.

FIG. 2 is an isometric view of a portion of the substrate carrier plate of FIG. 1.

FIG. 3A is a side cross-sectional view of the body of the substrate carrier plate along section lines 3A-3A of FIG. 2.

FIG. 3B is a side cross-sectional view of the body of the substrate carrier plate along section lines 3B-3B of FIG. 2.

FIG. 4 is a plan view of a system for batch processing of magnetic media utilizing the substrate carrier plate of FIG. 1.

FIG. 5 is an isometric view of a portion of the stage, a portion of the substrate carrier plate, and a portion of the flipper robot shown in FIG. 4.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Embodiments described herein generally provide apparatus and methods for deposition of materials onto substrates and/or treatment of materials previously deposited on substrates. The substrates may be annular disks having two major surfaces, such as substrates utilized in the production of magnetic media. The substrates as described herein may be made of glass, a composite glass/ceramic, a metal, or other suitable substrate for forming magnetic media. Embodiments of the invention may be utilized for deposition, treatment, and/or patterning of material on a plurality (i.e., a “batch”) of substrates. Embodiments described herein provide for deposition, treatment, and/or patterning of material on both of the major surfaces of the substrate but may also be applicable for deposition, treatment, and/or patterning of material on only one surface of the substrate. Additionally, embodiments of the invention may be utilized in processes such as metal or semiconducting material deposition, as well as other processes, such as etch processes, implant, lithography, and other processes where two major surfaces of the substrate are to be processed.

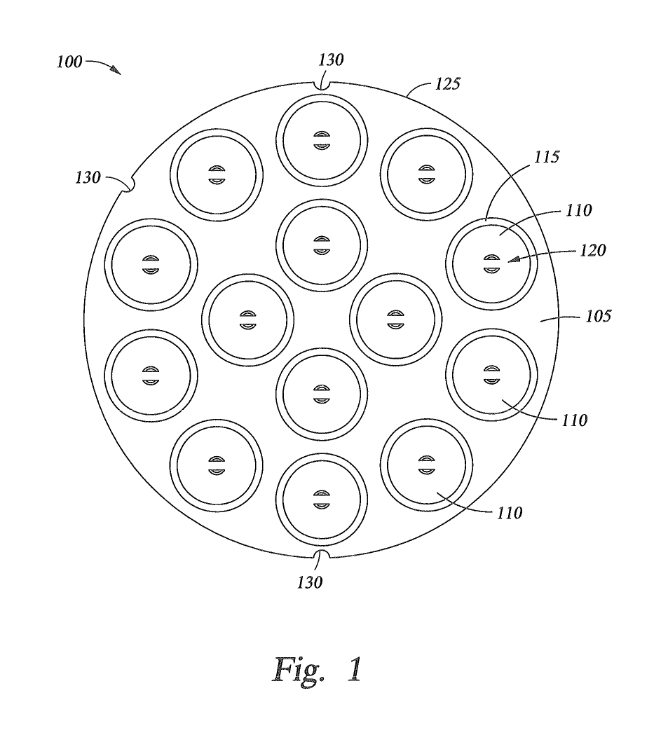

FIG. 1 is a top plan view of one embodiment of a substrate carrier plate 100. The substrate carrier plate 100 comprises a body 105 which may be substantially disk-shaped. The body 105 includes a plurality of pockets 110 formed thereon. Each of the pockets 110 may be substantially circular depressions that are utilized for receiving a substrate (not shown) and holding the substrate during transfer and processing. The body 105 may be made of a semiconductor material, such as group IV elements or compounds, for example silicon (Si), germanium (Ge), gallium (Ga), or combinations thereof and derivatives thereof. The semiconductor material may include a monocrystalline or polycrystalline structure. The body 105 may also be fabricated from a high-purity plastic material, such as polyetheretherketone (PEEK) or polytetrafluoroethylene (PTFE).

In one embodiment, each of the pockets 110 are formed in the body 105 of the substrate carrier plate 100. Each of the pockets 110 may also include recessed wall 115 and a support feature 120 formed in or near a center of the pocket 110. In one embodiment, the body 105 of the substrate carrier plate 100 is sized to be utilized in conjunction with standard semiconductor processing equipment. For example, the body 105 includes a diameter that is similar to a standard semiconductor wafer. Thus, the substrate carrier plate 100 may be transferred using standard transfer equipment (e.g., robotic equipment) and may be utilized for processing substrates in standard semiconductor processing chambers.

In one embodiment, the body 105 of the substrate carrier plate 100 includes a peripheral edge 125 having a diameter of about 300 millimeters (mm) to about 450 mm, or larger. The pockets 110 are nested within the body 105 to maximize the number of pockets 110 formed therein. In one example, the substrate carrier plate 100 may include fourteen (14) pockets 110 utilizing a body 105 having a diameter of about 300 mm. However, the number of pockets 110 may be greater than fourteen utilizing a body 105 having a diameter greater than 300 mm, or lesser than fourteen utilizing a body 105 having a diameter less than 300 mm. The peripheral edge 125 may also include one or more notches 130 formed therein. The notches 130 are utilized as indexing features for interfacing with an end effector or robotic equipment (not shown) that are used to transfer the substrate carrier plate 100 into, out of, or within a processing tool or tool interface (both not shown). In one aspect, the peripheral edge includes 3 notches 130, wherein at least two of the notches 130 are disposed one-hundred eighty degrees (180°) from each other. The third notch 130 may be positioned less than ninety degrees (90°) from one of the opposing notches 130. The recessed wall 115, the support features 120, and/or the notches 130 may be formed in the body 105 by etching, machining (i.e., milling) or a laminating process.

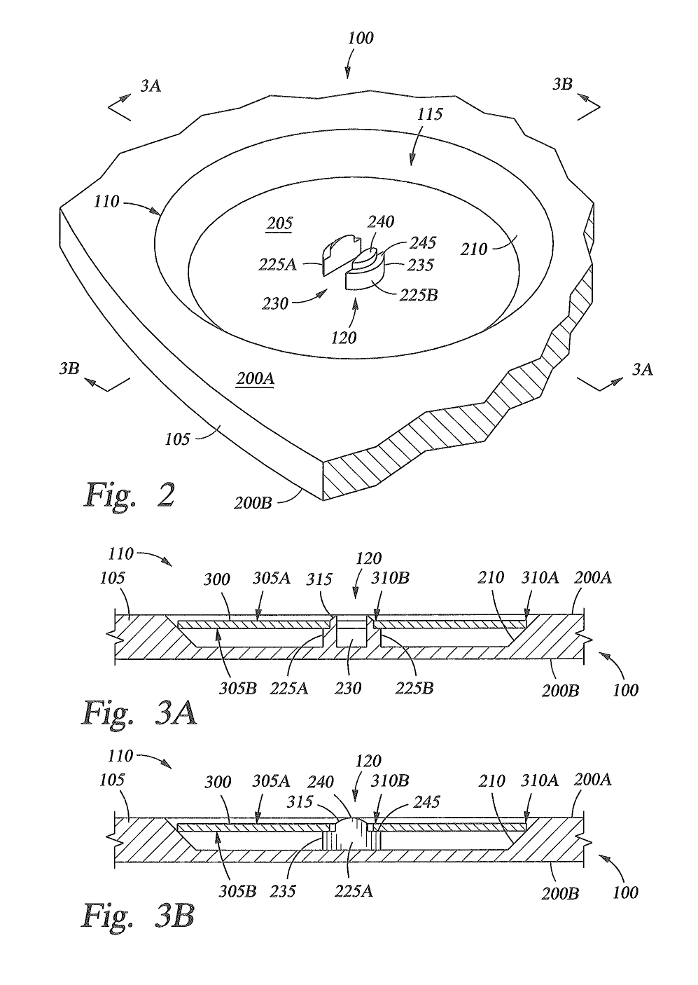

FIG. 2 is an isometric view of a portion of the substrate carrier plate 100 of FIG. 1. The body 105 of the substrate carrier plate 100 includes a first side 200A disposed in a first plane and a second side 200B opposing the first side 200A. The first side 200A and the second side 200B may be substantially planar and parallel. The pocket 110 includes a lower surface 205 disposed in a second plane that is offset from the first plane of the first side 200A. The lower surface 205 may be parallel with the plane of the first side 200A and/or the second side 200B. The recessed wall 115 of the substrate carrier plate 100 of FIG. 1 connects the surface of the first side 200A and the lower surface 205, which in this aspect is a tapered sidewall 210 that extends from the first side 200A to the lower surface 205. The tapered sidewall 210 may be utilized to center and/or support a peripheral edge of a substrate (not shown) that may be positioned in the pocket 110. The tapered sidewall 210 may include a planar surface disposed at an angle of about thirty degrees (30°) to about fifty five degrees (55°) from the plane of the first side 200A and/or the lower surface 205, such as about forty five degrees (45°).

Each pocket 110 is utilized to hold a disk-shaped substrate (not shown) having a central aperture formed therethrough. The inner diameter surface of the central aperture of the substrate is configured to align with the support feature 120. The support feature 120 includes a split protrusion having a first portion 225A and a second portion 225B separated by a gap 230. Each of the first portion 225A and the second portion 225B may be substantially similar in construction and size. Each of the first portion 225A and the second portion 225B include a first semicircular structure 235 having an outer wall formed along a radius, extending from the center of the pocket 110 that is larger than the radius of the inner diameter surface of a substrate to be received therein. Each of the first portion 225A and the second portion 225B also include a second semicircular structure 240 having an outer wall formed along a radius, centered at the center of the pocket 110, that is slightly less than the inner diameter surface of an annular substrate, such that a support surface 245 extending generally parallel with the plane of the first side 200A is defined therebetween.

FIG. 3A is a side cross-sectional view of the body 105 along section lines 3A-3A of FIG. 2. FIG. 3B is a side cross-sectional view of the body 105 along section lines 3B-3B of FIG. 2. A substrate 300 is shown disposed in the pocket 110 shown in FIGS. 3A and 3B. The substrate 300 has a first major surface 305A and a second major surface 305B. One or both of the first major surface 305A and the second major surface 305B of the substrate 300 may need to be processed. The substrate 300 also includes a peripheral portion 310A and a central portion 310B. Both of the central portion 310B and the peripheral portion 310A may be a circular surface having a diameter, wherein the central portion 310B includes a diameter that is less than a diameter of the peripheral portion 310A.

When the substrate 300 is disposed in the pocket 110, the central portion 310B of the second major surface 305B of the substrate 300 rests on the support surface 245 of the support feature 120 and the peripheral portion 310A of the second major surface 305B of the substrate 300 may at least partially contact and be supported by the tapered sidewall 210. An upper surface 315 of the second semicircular structure 240 of the support feature 120 may be rounded, tapered or beveled, as shown in FIGS. 3A and 3B, to facilitate centering of the substrate 300 in the pocket 110. In one embodiment, at least a portion of the upper surface 315 is coplanar with the first side 200A of the body 105 of the substrate carrier plate 100.

The substrate 300 is disk-shaped (i.e., annular) and configured for use in hard disk drives. The central portion 310B of the substrate 300 includes an inner diameter surface and the peripheral portion 310A includes an outer diameter surface. A portion of the first major surface 305A and the second major surface 305B of the substrate 300 adjacent the central portion 310B are not utilized for memory storage space to enable coupling to a spindle in a hard disk drive apparatus. Thus, an inner edge exclusion zone is intentionally created and/or formed on the first major surface 305A and the second major surface 305B of the substrate 300 adjacent the central portion 310B. The support surface 245 is utilized to center and/or support the center surface the substrate 300 adjacent to, and radially outward of, the inner wall thereof, but within the span of the inner exclusion zone of the substrate 300. Additionally, the tapered sidewall 210 of each pocket 110 may be utilized to center and/or support the peripheral portion 310A of the substrate 300 that is positioned in the pocket 110. As the substrate 300 is not gripped on the peripheral portion 310A, more surface area of the substrate 300 is available for deposition. Thus, deposition on the upper surface of the substrate 300 (the first major surface 305A in FIGS. 3A and 3B) may be performed without any exclusion on the peripheral edge of the substrate 300.

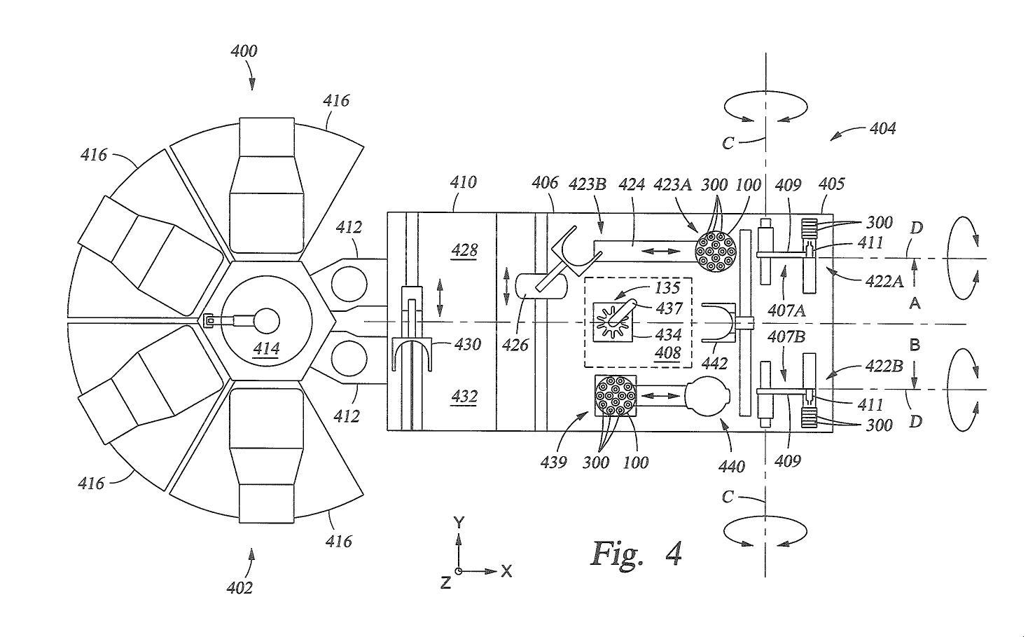

FIG. 4 is a plan view of a system 400 for batch processing of magnetic media utilizing the substrate carrier plate 100 of FIG. 1. The system 400 comprises a substrate processing module 402 and a substrate handling module 404 coupled to the substrate processing module 402. The substrate handling module 404 comprises a loader section 405, a transfer section 406, a flipper module 408, and a tool interface 410. The substrate processing module 402 has a one or more load-lock chambers 412, a transfer chamber 414, and a plurality of processing chambers 416.

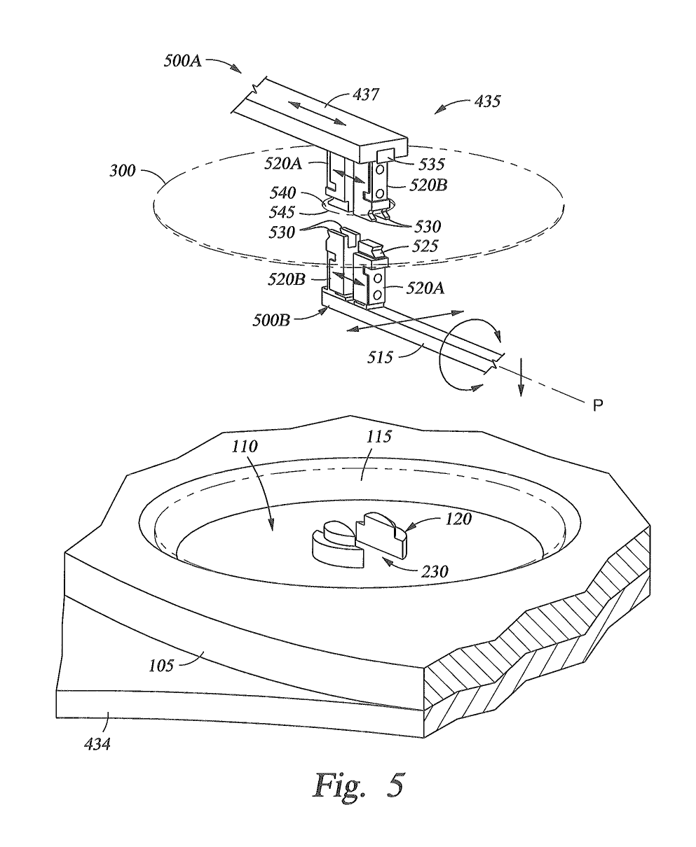

The substrate handling module 404 is utilized to transfer substrates 300 between the loader section 405 where one or more substrates 300 may be loaded/unloaded for processing in the substrate processing module 402 on one or more substrate carrier plates 100. The loader section 405 includes a tray 422A located on an input side “A” of the system 400 and a tray 422B located on an output side “B” of the system 400. Each substrate carrier plate 100 is adapted to hold a plurality of substrates 300 for transfer within the transfer section 406 and processing in the substrate processing module 402. The substrates 300 may be vertically oriented within the trays 422A and 422B. The loader section 405 includes a loader robot 407A and an off-loader robot 407B to transfer substrates 300 from the tray 422A to the substrate carrier plate 100 and transfer substrates 300 from the substrate carrier plate 100 to the tray 422B, respectively. Each of the loader robot 407A and the off-loader robot 407B include an arm 409 having a pick device 411 located at a distal end thereof. The pick device 411 is generally configured to grip the inner diameter of each substrate 300 during transfer. The pick device 411 may include articulatable jaws similar to the gripper devices 500A and 500B shown in FIG. 5. Each arm 406 is rotatable in axis C to transfer substrates 300 between the loader section 405 and the transfer section 406. Each of the pick devices 411 are rotatable in axis D to rotate the substrates 300 from a vertical orientation to a horizontal orientation.

In operation, the tray 422A is loaded with substrates 300 to be processed. The substrates 300 may be provided to the tray 422A having one or more metal layers disposed thereon, as well as a magnetic film and optionally a patterned mask or resist, and the system 400 may be utilized to perform additional processing on each of the substrates 300.

The loader robot 407A is configured to pick substrates 300 from the tray 422A and place substrates 300 onto the substrate carrier plate 100 located at a first position 423A within the system 400. The loader robot 407A transfers the substrates 300 one at a time from a vertical orientation in the tray 422A to a horizontal orientation for placement in pockets 110 of the substrate carrier plate 100. The substrate carrier plate 100, having to be processed substrates 300 thereon, may be transferred along a rail 424 to a second position 423B within the system 400. The second position 423B allows the substrate carrier plate 100 to be accessed and transferred by a carrier plate loader 426 disposed between the rail 424 and the tool interface 410. The carrier plate loader 426 transfers the substrate carrier plate 100 to an input stage 428 of the tool interface 410 where the substrate carrier plate 100 may be transferred to one of the load lock chambers 412. A transfer robot 430 within the tool interface 410 may be utilized to transfer the substrate carrier plate 100 into the load lock chamber 412. The load lock chamber 412 may be pumped down and the substrate carrier plate 100 may be transferred to one or more of the processing chambers 416 of the substrate processing module 402 where a first side (i.e., a first major surface 305A (shown in FIGS. 3A and 3B)) of each of the plurality of substrates 300 may be processed may be processed while disposed on the substrate carrier plate 100. For example, the first side of each of the substrates 300 may undergo additional processing in the processing chambers 416, where a cap layer may deposited on the first side, and other processes, such as etching, implant, and stripping may be performed on the substrates 300.

After the first side of each of the substrates 300 is processed, the substrate carrier plate 100, having the processed substrates 300 thereon, is transferred through another one of the load lock chambers 412 to an output stage 432 of the tool interface 410. The substrate carrier plate 100 may be transferred to the flipper module 408 that facilitates repositioning of the substrates 300 on the substrate carrier plate 100. One or both of the transfer robot 430 and the carrier plate loader 426 may be utilized to position the substrate carrier plate 100 onto a stage 434 of the flipper module 408. The flipper module 408 includes a flipper robot 435 having a plurality of first gripper devices and second gripper devices (both are shown in FIG. 5) disposed on a support arm 437.

As will be explained in greater detail in FIG. 5, the first gripper devices of the flipper robot 435 remove each of the substrates 300 simultaneously from the substrate carrier plate 100 and transfer each of the substrates 300 simultaneously to the second gripper devices. The second gripper devices then transfer each of the substrates 300 onto the substrate carrier plate 100 with the first side (i.e., processed side) down and a second side (i.e., a second major surface 305B (shown in FIGS. 3A and 3B)) up, where the second side may be processed.

After the substrates 300 have been flipped on the substrate carrier plate 100, the second side of the substrates 300 may be processed. The substrate carrier plate 100 may be transferred to the input stage 428 of the tool interface 410 where the substrate carrier plate 100 is transferred to one of the load lock chambers 412 and into the substrate processing module 402 for processing the second side of the substrates 300. When processing on the second side of the substrates 300 is complete, the substrate carrier plate 100 may be transferred through another one of the load lock chambers 412 to the output stage 432 of the tool interface 410. The substrate carrier plate 100 may then be transferred to a third position 439 in the system 400. The third position 439 may be a portion of a rail 438 that is accessed by the carrier plate loader 426. The substrate carrier plate 100 may be transferred along the rail 438 to a fourth position 440 where the substrates 300 may be unloaded from the substrate carrier plate 100 utilizing the off-loader robot 407B. The off-loader robot 407B places the processed substrates 300 into the tray 422B for transfer to other processing tools outside of the system 400. When the substrate carrier plate 100 is empty, a carrier plate robot 442 may transfer the substrate carrier plate 100 from the fourth position 440 to the first position 423A for reloading by the loader robot 407A.

FIG. 5 is an isometric view of a portion of the stage 434, a portion of the substrate carrier plate 100, and a portion of the flipper robot 435 shown in FIG. 4. The flipper robot 435 includes a plurality of off-loading gripper devices and a plurality of re-loading gripper devices. Only one off-loading gripper device is shown as a first gripper device 500A, and, only one re-loading gripper device is shown as a second gripper device 500B, the flipper robot 435 shown in FIG. 4 may have a number of off-loading gripper devices and a number of re-loading gripper devices equal to the number of pockets 110 in the substrate carrier plate 100 to enable simultaneous transfer of substrates 300 from/to the substrate carrier plate 100. For example, if the substrate carrier plate 100 includes fourteen (14) pockets 110, the flipper robot 435 would include fourteen (14) first gripper devices 500A and fourteen (14) second gripper devices 500B.

The first gripper device 500A is utilized to transfer a substrate 300 from a pocket 110 disposed on the substrate carrier plate 100 and hand-off the substrate 300 to the second gripper device 500B. After transfer of the substrate 300 from the first gripper device 500A to the second gripper device 500B, the second gripper device 500B is rotated about axis P and then transfers the substrate 300 into the pocket 110.

In one embodiment of a substrate flip sequence, the first gripper device 500A may be coupled to a support arm 437 that is positioned above the stage 434 and the substrate carrier plate 100. The support arm 437 may be fixed such that the support arm 437 does not move relative to the stage 434 and/or the substrate carrier plate 100. The second gripper device 500B is coupled to an arm 515 that is actuated to move to a first position to space the second gripper device 500B away from the first gripper device 500A and a second position that is intermediate of the first gripper device 500A and the substrate carrier plate 100 as shown in FIG. 5.

To remove a substrate 300 having a first side processed, the stage 434 is moved toward the first gripper device 500A as the second gripper device 500B is in the first position and spaced away from the first gripper device 500A. The stage 434 is moved toward the first gripper device 500A to bring the substrate carrier plate 100 into proximity with the first gripper device 500A.

The first gripper device 500A and the second gripper device 500B have a first end effector 520A and a second end effector 520B. Each of the first end effectors 520A include a single notched plate 525 centrally located on the end of the first end effector 520A. Each of the second end effectors 520B include two notched plates 530 peripherally located on the end of the second end effector 520B. The two notched plates 530 of the second end effector 520B form a slot into which the single notched plate 525 of the first end effector 520A may fit therebetween. The first end effector 520A is constructed similarly. Both of the two notched plates 530 and the single notched plate 525 on each of the first gripper device 500A and the second gripper device 500B are sized to fit within the gap 230 of the support feature 120. Each gripper device 500A, 500B includes an actuator 535 (only one is shown on gripper device 500A). The end effectors 520A and 520B of each gripper device 500A, 500B are actuated by the actuator 535 that retracts the end effectors 520A and 520B, bringing them closer together (as shown by the arrows) for insertion into the central opening 540 of the substrate 300, and then extends the end effectors 520A and 520B apart until the single notched plate 525 and the two notched plates 530 contact an internal edge 545 of the substrate 300.

When the substrate carrier plate 100 is in proximity with the first gripper device 500A, the end effectors 520A and 520B are inserted into the central opening 540 of the substrate 300, the end effectors 520A and 520B being retracted relative to each other. After insertion, the end effectors 520A and 520B are actuated to extend/separate the end effectors 520A and 520B allowing the two notched plates 530 and the single notched plate 525 to engage the internal edge 545 of the substrate 300. When the substrate 300 is supported by the end effectors 520A and 520B, the stage 434 may be actuated downward or away from the end effectors 520A and 520B to remove the substrate 300 from the substrate carrier plate 100. The arm 515 of the second gripper device 500B is then actuated to position the second gripper device 500B in the second position where the second gripper device 500B is intermediate of the first gripper device 500A and the substrate carrier plate 100 as shown in FIG. 5. The second gripper device 500B may be moved in proximity to the backside of the substrate 300.

The end effectors 520A, 520B facilitate transfer of substrates from one gripper device to another as follows. The end effectors 520A and 520B of the second gripper device 500B may be retracted (i.e., brought together) such that the single notched plate 525 and the two notched plates 530 of the second gripper device 500B may be inserted into the central opening 540 of the substrate 300. The single notched plate 525 of the second gripper device 500B is sized to be received between the two notched plates 530 of the first gripper device 500A. Likewise, the single notched plate 525 of the first gripper device 500A is sized to be received between the two notched plates 530 of the second gripper device 500B. After insertion of the second gripper device 500B into the central opening 540 of the substrate 300 and the single notched plate 525 of the first gripper device 500A is intermediate of the two notched plates 530 of the first gripper device 500A, the second gripper device 500B is actuated to extend the end effectors 520A and 520B thereof to allow the two notched plates 530 and the single notched plate 525 to engage the internal edge 545 of the substrate 300. The first gripper device 500A may then disengage the substrate 300 by retracting the first end effector 520A relative to the second end effector 520B. The arm 515 and the second gripper device 500B, which is now gripping the substrate 300, may move downward and away from the first gripper device 500A. The arm 515 may be rotated in axis P to reverse the orientation of the first side and the second side of the substrate 300. The substrate 300 may then be positioned in the pocket 110 by one or a combination of movement of the arm 515 and the stage 434. Once the substrate 300 is in at least partial contact with the support feature 120, the first end effector 520A and the second end effector 520B of the second gripper device 500B may be retracted relative to each other, which releases the substrate 300. The arm 515 and the second gripper device 500B may be moved upwards to clear the substrate 300 and the substrate carrier plate 100 may be transferred by robotic equipment in the system 400.

Embodiments described herein provide for deposition, treatment, and/or patterning of material on two opposing major surfaces of a substrate, while preventing damage to either of the surfaces that has been previously processed. The embodiments include a substrate carrier plate utilized to support and transfer a batch of substrates within a processing system for multiple processes. In one embodiment, the substrate carrier plate is sized to be utilized in conjunction with standard semiconductor transfer and processing equipment, such as robots, chambers, and the like, which allows the use of the substrate carrier plate with existing processing equipment.

While the foregoing is directed to embodiments of the invention, other and further embodiments of the invention may be devised without departing from the basic scope thereof.

What is claimed is:

1. A carrier plate for supporting a plurality of substrates, the carrier plate comprising:
a disk-shaped body having a first side and a substantially planar second side opposite the first side; and
a plurality of depressions formed in the first side of the disk-shaped body, each of the plurality of depressions comprising:
a sidewall tapering from a surface of the first side and a bottom surface of the depression; and
a support structure disposed above the bottom surface of the depression and geometrically centered in the depression.

2. The carrier plate of claim 1, wherein the support structure includes an upper surface that is parallel with a plane of the surface of the first side.

3. The carrier plate of claim 1, wherein the support structure comprises a substantially semicircular support surface.

4. The carrier plate of claim 3, wherein the support surface is offset from the plane of the surface of the first side.

5. The carrier plate of claim 3, wherein the support surface is offset a distance from the plane of the first side, the distance being substantially equal to a thickness of a single one of the plurality of substrates.

6. The carrier plate of claim 3, wherein the support structure comprises a first semicircular support surface and a second semicircular support surface.

7. The carrier plate of claim 6, wherein the first semicircular support surface and the second semicircular support surface are separated by a gap.

8. The carrier plate of claim 1, wherein the disk-shaped body comprises silicon.

9. The carrier plate of claim 1, wherein a peripheral edge of the disk-shaped body comprises one or more notches formed therein.

10. A carrier plate for supporting a plurality of substrates, the carrier plate comprising:
a disk-shaped body having a first side and a substantially planar second side opposite the first side; and
a plurality of pockets formed in the first side of the disk-shaped body, each of the pockets comprising:
a sidewall disposed between a surface of the first side and a bottom surface of the pocket; and
a support structure disposed above the bottom surface, the support structure comprising one or more substantially semicircular support surfaces.

11. The carrier plate of claim 10, wherein the support structure is geometrically centered in the pocket.

12. The carrier plate of claim 10, wherein the sidewall is tapered at an angle relative to the surface of the first side.

13. The carrier plate of claim 10, wherein the support structure comprises a first semicircular support surface and a second semicircular support surface.

14. The carrier plate of claim 13, wherein the first semicircular support surface and the second semicircular support surface are separated by a gap.

15. The carrier plate of claim 10, wherein the disk-shaped body comprises silicon.

16. The carrier plate of claim 10, wherein a peripheral edge of the disk-shaped body comprises one or more notches formed therein.

17. A carrier plate for supporting a plurality of substrates, the carrier plate comprising:
a disk-shaped body having a first side and a substantially planar second side opposite the first side; and
a plurality of pockets formed in the first side of the disk-shaped body, each of the pockets comprising:
a sidewall tapering from a surface of the first side and a bottom surface of the pocket; and
a support structure comprising one or more substantially semicircular support surfaces disposed above the bottom surface of, and geometrically centered in, the pocket.

18. The carrier plate of claim 17, wherein the support structure comprises a first semicircular support surface and a second semicircular support surface.

19. The carrier plate of claim 18, wherein the first semicircular support surface and the second semicircular support surface are separated by a gap.

20. The carrier plate of claim 17, wherein the disk-shaped body comprises silicon.
